(19) United States
(12) Patent Application Publication
(10) Pub. No.: US 2026/0269690 A1
(43) Pub. Date: Sep. 10, 2026

(54) Electric Motor

(71) Applicant: Innomotics GmbH, Nürnberg (DE)

(72) Inventor: Frank Brütting, Erlangen (DE)

(73) Assignee: Innomotics GmbH, Nürnberg (DE)

(21) Appl. No.: 18/847,048

(22) PCT Filed: Mar. 1, 2023
(86) PCT No.: PCT/EP2023/055095

§ 371 Date: Sep. 13, 2024

(30) Foreign Application Priority Data
Mar. 18, 2022 (EP) 22162925.6

(51) Int. Cl. H02K 9/22; H02K 1/16; H02K 9/06; H02K 11/33

(52) U.S. Cl. CPC H02K 9/225; H02K 1/16; H02K 9/06; H02K 9/227; H02K 11/33; H02K 2211/03

(57) ABSTRACT

Various embodiments of the teachings herein include an electric motor. An example includes: a stator having a plurality of field conductors; a plurality of inverters to control the field conductors arranged on one or more circuit boards; wherein the one or more circuit boards are arranged on a cooling plate; and a heat tube with an evaporator side arranged in the cooling plate and a condenser side arranged outside the cooling plate.

### CROSS-REFERENCE TO RELATED APPLICATIONS

This application is a U.S. National Stage Application of International Application No. PCT/EP2023/055095 filed Mar. 1, 2023, which designates the United States of America, and claims priority to EP Application No. 22162925.6 filed Mar. 18, 2022, the contents of which are hereby incorporated by reference in their entirety.

### TECHNICAL FIELD

The present disclosure relates to electric motors. Various embodiments of the teachings herein include electric motors with a stator-side bar winding.

### BACKGROUND

Electric motors can have a bar winding on the stator side. In this case the stator has a series of bars instead of wound wire conductors as field conductors. The bars have a low inductance compared to conventional windings. Hence a comparatively high current flow is required to generate a specified magnetic field. However, due to the low resistance of the bars, this high current flow requires only a comparatively low voltage of, for example, 12 V. The low voltage makes it possible to arrange the components of the inverters, with which the bars are controlled, at short distances from one another. Thus the components of the power electronics can for example be arranged on one or more circuit boards that are arranged close to the electric motor.

In addition to the high heat loss of the electrical and electronic components, which is caused by the high current intensities, a high packing density of the electrical and electronic components also occurs in the case of an electric motor designed in this way. It is possible that the air cooling or water cooling typically used at this point is not sufficient for the resulting power loss.

### SUMMARY

Teachings of the present disclosure include electric motors which eliminates the disadvantage cited in the introduction, in particular with an improved cooling performance for electrical and electronic components. For example, some embodiments include an electric motor (10, 20, 50, 60, 70) having: a stator (11) with a plurality of field conductors (12) designed as bars (12), a plurality of inverters for controlling the field conductors (12), Wherein the inverters are arranged on one or more circuit boards (15), the circuit boards (15) are arranged on at least one cooling plate (16), and at least one heat tube (30, 31, 51, 52, 61, 62, 71, 72) is present, whose evaporator side is arranged in the cooling plate (16) and whose condenser side is arranged outside the cooling plate (16).

In some embodiments, the heat pipe (30, 31, 51, 52, 61, 62, 71, 72) is designed in a straight line and, when the electric motor (10, 20, 50, 60, 70) is installed as intended, is arranged with an inclination of at least 10° to the horizontal.

In some embodiments, the circuit boards (15) are configured in the shape of a circle or of an annular sector.

In some embodiments, the cooling plate (16) is arranged perpendicular to the axis (9) of the electric motor (10, 20, 50, 60, 70).

In some embodiments, the cooling plate (16) is populated with circuit boards (15) on both sides.

In some embodiments, the electric motor (10, 20, 50, 60, 70) includes a plurality of heat pipes (30, 31, 51, 52, 61, 62, 71, 72).

In some embodiments, the electric motor (10, 20, 50, 60, 70) controls the field conductors (12) with at least 6 phases.

In some embodiments, the electric motor (10, 20, 50, 60, 70) includes a plurality of circuit boards (15).

In some embodiments, the heat pipe (30, 31, 51, 52, 61, 62, 71, 72) is connected on the condenser side to a plurality of cooling fins (32).

In some embodiments, at least some of the cooling fins (32) are mechanically connected to multiple heat pipes (30, 31, 51, 52, 61, 62, 71, 72).

In some embodiments, the cooling plate (16) has two cover surfaces and a surrounding jacket surface, wherein the circuit boards (15) are arranged on one of the cover surfaces or both cover surfaces and wherein the heat pipe (30, 31, 51, 52, 61, 62) passes through the jacket surface.

In some embodiments, the cooling plate (16) has two cover surfaces and a surrounding jacket surface, wherein the circuit boards (15) are arranged on one of the cover surfaces and wherein the heat pipe (71, 72) passes through the other cover surface.

In some embodiments, one or more fans are present to generate an air flow in the region of the cooling fins (32).

In some embodiments, the inverters are designed to generate an alternating voltage with an amplitude of 200 V or less, in particular 150 V or less, in particular 50 V or less.

### BRIEF DESCRIPTION OF THE DRAWINGS

The teachings of the present disclosure are described and explained in greater detail below on the basis of the exemplary embodiments represented in the figures, in which, shown schematically:

FIG. 1 shows an example electric motor incorporating teachings of the present disclosure with two cooling plates for cooling circuit boards and with heat pipes for cooling the cooling plate in a side view;

FIG. 2 shows the electric motor in a front view;

FIG. 3 shows a second embodiment for heat pipes in a side view;

FIG. 4 shows the second embodiment for the heat pipes in a front view;

FIG. 5 shows a modification of the second embodiment for the heat pipes in a side view;

FIG. 6 shows the lead-out of the heat pipes in the second embodiment in an oblique view;

FIG. 7 shows the lead-out in a side view;

FIG. 8 shows a third embodiment for the heat pipes in a front view;

FIG. 9 shows a fourth embodiment for the heat pipes in a front view;

FIG. 10 shows a fifth embodiment for the heat pipes in a side view; and

FIG. 11 shows a sixth embodiment for the heat pipes in a side view.

### DETAILED DESCRIPTION

In some embodiments, an electric motor comprises a stator with a plurality of field conductors designed as bars. The electric motor further comprises a plurality of inverters for controlling the field conductors, wherein the inverters are arranged on one or more circuit boards and the circuit boards are arranged on at least one cooling plate. Further, at least one heat pipe is present, whose evaporator side is arranged in the cooling plate and whose condenser side is arranged outside the cooling plate. Thanks to its enormous thermal conductivity, the heat pipe can also discharge the large amounts of spatially closely concentrated power losses that occur in this structure. There is no need to generate a forced air flow, at least in the immediate vicinity of the circuit boards, which is why moving parts are eliminated at least there.

In some embodiments, the heat pipe can be a straight line and when the electric motor is installed as intended can be arranged with an inclination of at least 10° to the horizontal. In particular, the inclination can also be at least 20° and in special configurations at least 45° or at least 60°. In this case the direction of the inclination is expediently such that the condenser is located above the evaporator. Since the inclination to the horizontal of heat pipes affects the efficiency, in other words the heat conduction, an optimal efficiency of the heat pipe may thus be ensured. At an inclination of 10°, depending on the type and configuration of the heat pipe, a heat transfer performance of 80% or more of the maximum possible performance is achieved, whereas below 10° this value drops rapidly and sharply.

The circuit boards can be designed in the shape of a circle or of an annular sector. Circuit boards with this shape can be assembled to form a circle or ring and thus can be arranged at an axial end of the machine in an optimal way to match the shape of the electric machine, wherein at the same time a high modularity is achieved. The terms “axial”, “radial” and “tangential” refer in this case to the axis of the rotor and thus to the corresponding axis of symmetry of the stator. In this case “axial” describes a direction parallel to this axis, “radial” describes a direction orthogonal to the axis, toward it or away from it, and “tangential” is a direction that is directed in a circle around the axis at a constant radial distance from the axis and at a constant axial position. The expression “in the circumferential direction” is equivalent to “tangential”.

If the terms “axial”, “radial” and “tangential” are used in relation to a surface, for example a cross-sectional surface, the terms describe the orientation of the normal vector of the surface, the vector that is perpendicular to the surface in question.

The cooling plate can be arranged perpendicular to the axis of the electric machine. In this way the cooling plate with the circuit boards can be arranged at one axial end of the electric machine to save space. A plurality of cooling plates can also be axially offset and arranged close to one another. At the same time, this offers the simple possibility of arranging the heat pipe or else multiple heat pipes perpendicularly or almost perpendicularly when the machine is installed as intended, thus achieving an optimum heat transfer. Furthermore, in the case of such an arrangement there is a uniform distance between the cooling plate and the power electronics from the bars that form the field conductors, as a result of which contacting of the bars is simplified.

The cooling plate can be populated with circuit boards on both sides. As a result, an improved space utilization is achieved. The heat pipe is optimally suited to discharge the increased heat input into the cooling plate. Thanks to the number of heat pipes used, it is possible to make an adaptation to the waste heat of the inverter circuits.

A plurality of heat pipes may be present. The electric motor can have one cooling plate or multiple cooling plates, each of which can have one heat pipe or multiple heat pipes. With a plurality of heat pipes, on the one hand more heat can be discharged and on the other hand the heat discharge from the cooling plate can be made more uniform, so that the temperature gradient in the cooling plate is advantageously minimized.

The electric motor can have a plurality of circuit boards. In particular, a plurality of separate circuit boards can be applied to a cooling plate. By distributing them across a plurality of circuit boards, the power electronics used can be modularized. Thus by using a plurality of similar circuit boards, a large number of converters can be provided, as a result of which production is improved as regards rejects.

The heat pipe can have a plurality of fins on the condenser side. The fins form a heat sink which thanks to its large surface area and at the same time low thermal mass and sufficient thermal conductivity ensures good heat dissipation to the ambient air. In some embodiments, a good through-flow provides efficient dissipation of heat transferred to the outside.

If the fins are designed for a passive through-flow, their spacing must be sufficient so as not to impede the air flow too much. A spacing of at least 4 mm may work for this. However, the heat sink can also be designed for an active through-flow, for example with one or more fans. In this case the spacing between the fins can be chosen to be less, for example only 1 mm.

At least some of the fins can be mechanically connected to multiple heat pipes. In other words, several of the heat pipes end in the heat sink formed by the fins. In addition to mechanical stabilization of the fins, this also results in a more uniform heat dissipation and thus a lower temperature gradient in the cooling plate.

The cooling plate can have two cover surfaces and a surrounding jacket surface, wherein the circuit boards are arranged on one of the cover surfaces or both cover surfaces and wherein the heat pipe passes through the jacket surface. The cooling plate is thus designed as a substantially cylindrical plate. As a result, the cover surfaces may be left completely free for the attachment of the circuit boards. Furthermore, the heat pipe can thus run straight through a wide area of the cooling plate, so that a high mechanical stability and an optimal heat transfer from the cooling plate to the heat pipe is achieved.

In some embodiments, the cooling plate can have two cover surfaces and a circumferential jacket surface, wherein the circuit boards are arranged on one of the cover surfaces and wherein the heat pipe passes through the other cover surface. If space permits, the heat sink with the fins can thus be moved to the area behind the cooling plate instead of to the side of the cooling plate. As a result, the radial space requirement of the machine is significantly reduced and instead the length of the machine is increased in the axial direction.

The inverters can be designed to generate an alternating voltage with an amplitude of 200 V or less, in particular 150 V or 100 V or less, in particular 20 V or less. The voltage thus generated is the voltage applied to the field conductors, in other words the stator bars. Thanks to this comparatively low voltage it is possible for the components of the inverters to be arranged very close to one another. Spacings of approximately 2 mm between the components such as the power semiconductor switches can be used, as a result of which there is a high packing density of the electronic components and it is possible to arrange a plurality of inverters in a comparatively small space. This in turn makes it possible to use a large number of phases, in particular a number of phases corresponding to the number of stator bars, while taking up little space. Thus with a correspondingly high number of stator bars, 12, 24 or even 48 phases can be used.

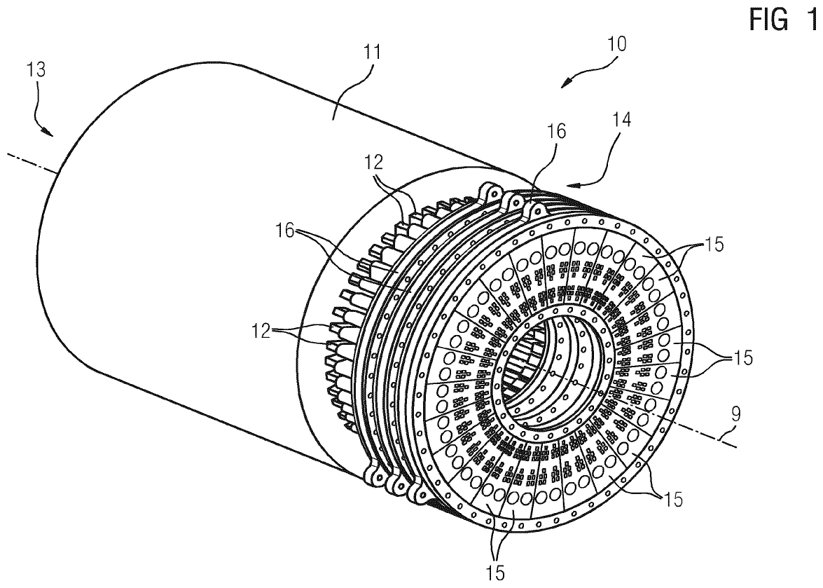

FIG. 1 shows an isometric view of an example electric motor 10 incorporating teachings of the present disclosure. The electric motor 10 comprises a stator 11 and a rotor which is arranged substantially in the stator 11 and is not visible in FIG. 1. The rotor is rotationally fixedly connected to a shaft, which is likewise not shown in FIG. 1. The rotor is caused to rotate about an axis 9 by electromagnetic interaction of the rotor with the energized stator 11. The rotor is in this case separated from the stator 11 by an air gap.

The stator 11 comprises a plurality of rigid and straight conductor bars 12 as field conductors. These conductor bars 12 are connected to one another via a short-circuit ring on the end face 13 facing away in FIG. 1. On the rear side 14 of the electric motor 10, the conductor bars 12 are individually fed by respectively associated inverter modules. Since the conductor bars 12 result in an electric motor 10 operating at low voltages, the inverter modules can be arranged relatively close together on circuit boards 15, together with other electronic components (DC/DC converters, rectifiers). In this example, the circuit boards are in the shape of an annular sector and many individual circuit boards 15 together form an annular circuit board structure.

Whereas it is assumed in the examples that the circuit boards 15 carry inverter modules, it is also possible for some of the circuit boards to carry 15 rectifiers and DC/DC converters.

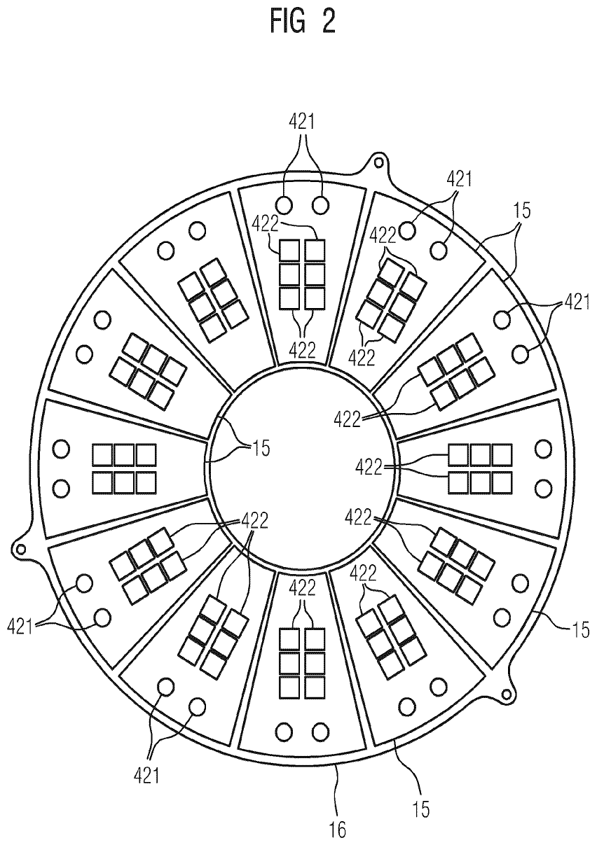

FIG. 2 shows a top view of such a circuit board structure. The number of circuit boards shown in FIG. 2 is in this case reduced compared to the representation in FIG. 1 and is shown in a highly simplified manner for better clarity. The specific number of such circuit boards 15 depends on the specific design of the electric motor 10, in particular the number of conductor bars 12. Each of the circuit boards 15 comprises multiple semiconductor switches 422.

Furthermore, some or all of the circuit boards 15 may comprise driver circuits and other electronic components such as capacitors not shown in the figures. The semiconductor switches 422 are power semiconductors such as for example IGBTs, MOSFETs or JFETs and, depending on the circuitry, can additionally comprise diodes (not shown). The semiconductor switches 422 are for example connected as half-bridges. A capacitor (not shown) can for example represent an intermediate circuit capacitor of the half-bridges. The semiconductor switches 422 of a circuit board 15 can in this case be assigned to a single phase or else to multiple phases.

The circuit boards 15 further comprise contact points 421, to which the conductor bars 12 are connected. The circuit boards 15 are supported by disk-shaped cooling plates 16, wherein the cooling plates 16 can be populated with circuit boards 15 on both sides for a better utilization of space.

Since relatively high currents are required in the conductor bars in the case of the electric motor 10, multiple inverters are may be connected in parallel to supply them with current. This can be achieved for example in that the six circuit board structures on three cooling plates 16 shown in FIG. 1 are all connected in the same way to the conductor bars 12 and are thus electrically connected in parallel. This takes advantage of the fact that the conductor bars 12 or connecting elements to the conductor bars 12 penetrate the cooling plates 16 and thus also the circuit boards 15 in the same way at the contact points or, in the case of the outermost cooling plate 16, at least contact them.

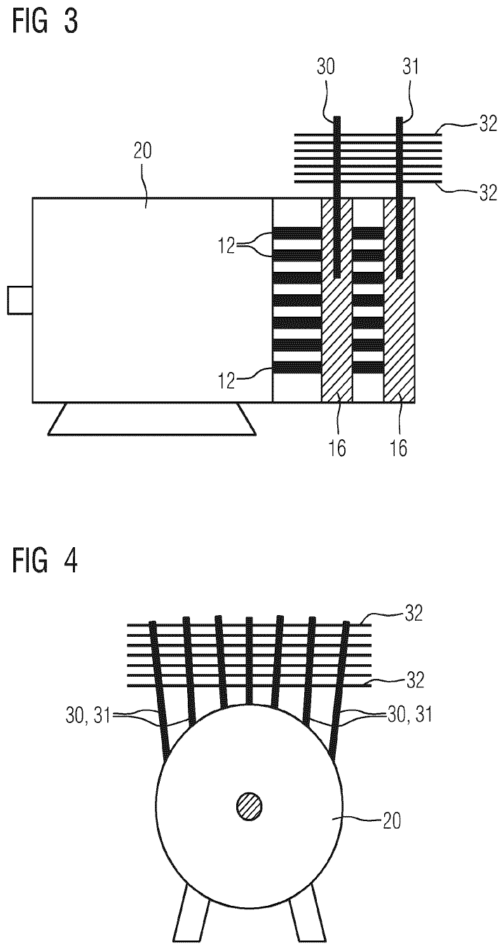

FIGS. 1 and 2 show no active measures for cooling the power electronic components. These are shown in a greatly simplified manner in FIGS. 3 to 6. FIG. 3 shows an exemplary electric motor 20 with two cooling plates 16 for spreading the heat loss of the power electronic components and with heat pipes 30, 31 for cooling the cooling plates 16 in a side view. FIG. 4 shows a front view of the same electric motor 20. It can be seen that each of the cooling plates is cooled by a plurality (here: 6) of heat pipes 30, 31.

The heat pipes 30, 31 are in this case introduced into the cooling plate 16 by their evaporator-side end and run in a straight line through the power converter housing into the outside space. In this case the course of the heat pipes 30, 31 is almost perpendicular when the electric motor 20 is installed as intended. Thanks to an arrangement far from the horizontal, the heat transfer of the heat pipes 30, 31 is optimized.

Recooling of the heat pipes 30, 31 at their condenser-side end is supported by a plurality of cooling fins 32. In this example, the cooling fins 32 are extended so that each of the cooling fins 32 is connected to each of the heat pipes 30, 31. The heat pipes can for example be copper-water heat pipes.

In particular designs it is possible to support the dissipation of heat to the surrounding air by active cooling with fans. Furthermore, it is possible to allow some of the heat pipes 30, 31 to protrude further into the respective cooling plate 16 in order to better distribute the evaporator-side ends of the heat pipes 30, 31 in the cooling plate 16 and thus achieve a more uniform heat dissipation.

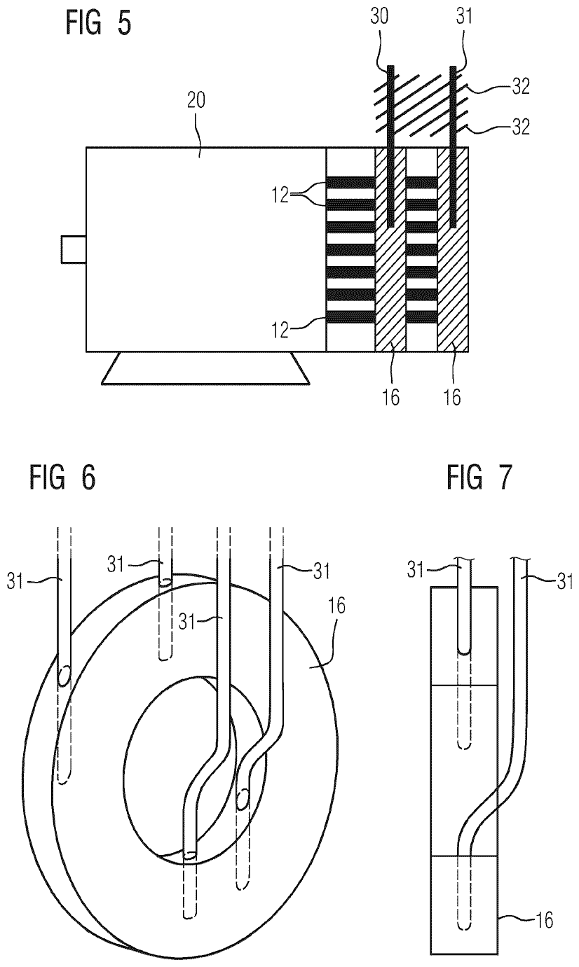

A further alternative is to arrange the condenser-side ends of the heat pipes 30, 31 at the location of the cooling fins 32, such that a heat exchange takes place with the power converter housing. FIG. 5 shows a modification of the second embodiment. In this modification, which is shown in a side view, the cooling fins 32 are arranged at an angle to the horizontal. This improves passive cooling, since the chimney effect ensures an improved through-flow of air through the cooling fins 32.

Those of the heat pipes 31 whose evaporator-side end ends in upper parts of the cooling plate 16—when the electric motor 20 is installed as intended-are led out of the cooling plate 16 in a straight line. For those of the heat pipes 31 whose evaporator-side end ends in lower parts of the cooling plate 16, a similar routing of the heat pipes 31 would result in them also passing through upper parts of the cooling plate 16.

Since this is disadvantageous for according to one embodiment shown in the detailed views in FIGS. 6 and 7, that such heat pipes 31 are led out of the plane of the cooling plate 16 in the region of the central opening by a curved course and then the further distance up to the cooling fins 32 runs parallel to the cover surface of the cooling plate 16. As a result, the heat pipes 31 are only connected to the cooling plate 16 in the region of their evaporator side.

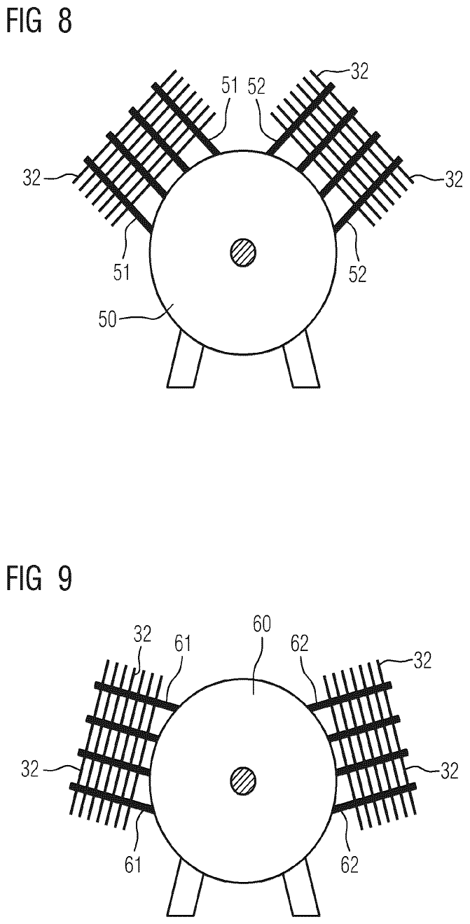

FIG. 8 shows a further exemplary embodiment incorporating teachings of the present disclosure. In the electric motor 50 shown in a front view, the heat pipes 51, 52 are arranged at an angle of approximately 40° to the perpendicular and lead out of the cooling plates 16 on two sides. In this case, the cooling fins 32 no longer enclose all existing heat pipes 51, 52, but only those on one side. Thanks to the changed arrangement of the heat pipes 51, 52, the cooling fins 32 are no longer arranged horizontally, but are likewise tilted by an angle of approximately 40° relative to the horizontal. Thanks to the chimney effect there is here an improved through-flow of air through the cooling fins 32 and thus an improved passive heat dissipation compared to the exemplary embodiment in FIGS. 3 and 4.

FIG. 9 shows a further exemplary embodiment incorporating teachings of the present disclosure. In the electric motor 60 shown in a front view, the heat pipes 61, 62 are arranged at an even greater angle to the perpendicular than in the example in FIG. 8, in this case approx. 80°. The cooling fins 32 can now be arranged perpendicularly. Due to the almost horizontal arrangement, the heat transfer of the heat pipes 61, 62 is no longer as good as in the previously described examples. However, due to the chimney effect there is a passive through-flow of air through the cooling fins 32 and thus a passive heat dissipation.

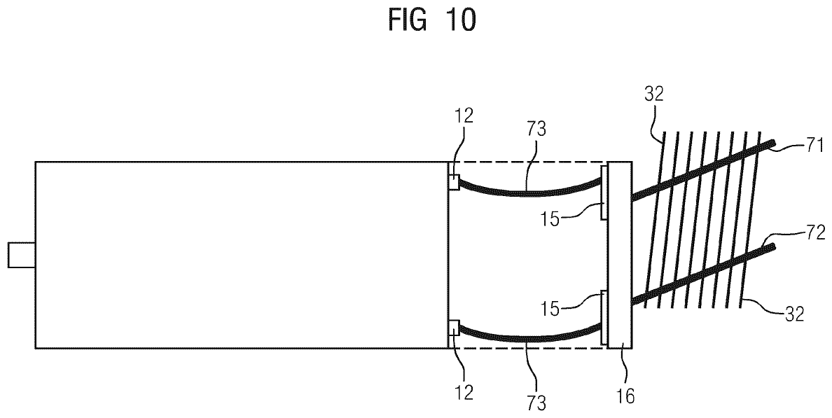

FIG. 10 shows a further exemplary embodiment incorporating teachings of the present disclosure. In the electric motor 70 shown in a side view, the heat pipes 71, 72 are arranged completely differently than in the previously described exemplary embodiments. The form of embodiment in FIG. 10 is primarily suitable for electric motors 70 in which only a single cooling plate 16 is present and in which this is only populated with circuit boards 15 on one side-facing the motor. In this example, the circuit boards 15 are connected to the conductor bars 12 by means of copper cables 73.

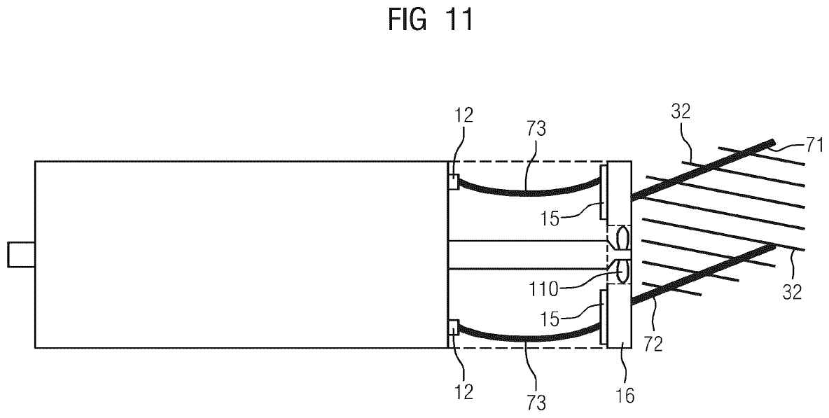

In the form of embodiment in FIG. 10, the heat pipes 71, 72 do not extend in the plane of the cooling plate 16, but rather are led out through its cover surface, wherein they are oriented toward the side facing away from the motor. In this example, the heat pipes 71, 72 are six heat pipes, which however are arranged in two rows and hence only appear as two heat pipes 71, 72 in FIG. 11. In some embodiments, the heat pipes 71, 72 have an inclination to the horizontal when the electric motor 70 is installed as intended, wherein the condenser side is located above the evaporator side. In this example, the cooling fins 32 again enclose all heat pipes 71, 72 and their surface normal is substantially horizontal, which ensures a good through-flow of air.

In some embodiments, the electric motor 70 has a more elongated shape, in which the heat pipes 71, 72 increase the circumference of the electric motor 70 less significantly. In such electric motors 70, which are intended to be installed so that the axis 9 is in the perpendicular position, the embodiment shown in FIG. 10 can likewise be used. In this case, the heat pipes 31 can be led out perpendicular to the surface of the cooling plates 16. The cooling fins 32 can in turn be arranged perpendicular to the heat pipes 31, meaning that they would ultimately be horizontal when installed as intended. To improve the air flow, an inclined position in the arrangement of the cooling fins 32 may again be preferred here.

In a design in which the heat pipes 71, 72 are led out of the cover surface of the cooling plates 16, active cooling can preferably be achieved by a fan 110 which is arranged in the middle of the central opening of the cooling plate 16, in particular directly on the shaft of the electric motor 70. In this case, it is advantageous if, other than shown in FIG. 10, the cooling fins 32 are not arranged almost perpendicularly, but rather horizontally or almost horizontally, in order to enable a good through-flow of the air driven by the fan 110. Such a design is shown in FIG. 11.

Whereas the examples described use cooling fins 32 to cool the condenser side of the heat pipes 30, 31, 51, 52, 61, 62, 71, 72, ribbed coolers or heat exchangers can instead be connected to the heat pipes 30, 31, 51, 52, 61, 62, 71, 72. Besides the described structures with a one-sided electrical supply of the electric motor 10, 20, 50, 60, 70, there is also the possibility of a two-sided electrical supply. Cooling plates 16 with circuit boards 15 are arranged at both axial ends of the electric motor 10, 20, 50, 60, 70. In this case too, the cooling plates 16 can be provided with respective heat pipes 30, 31, 51, 52, 61, 62, 71, 72.

If the cooling fins 32 are provided with holes for the current bars to the motor, it is possible to extend the embodiment variant in FIGS. 8 or 9 such that a plurality of cooling plates 16 is present with respective heat pipes 71, 72 and cooling fins 32, wherein the current bars are routed through the holes. In this case it is possible for the heat pipes 71, 72 to be led out of the cooling plates 16 on the same side. However, it is also possible in an alternative design for the heat pipes 71, 72 of two cooling plates 16 to be led out of the cooling plates 16 facing each other.

### REFERENCE CHARACTERS

9 Motor axis
10, 20, 50, 60, 70 Electric motor
11 Stator
12 Conductor bars
13 End face
14 Rear side
15 Circuit board
16 Cooling plate
30, 31, 51, 52, 61, 62, 71, 72 Heat tube
32 Cooling fins
421 Contact points
422 Semiconductor switches

What is claimed is:

1. An electric motor comprising:
a stator having a plurality of field conductors;
plurality of inverters to control the field conductors,
arranged on one or more circuit boards;
wherein the one or more circuit boards are arranged on a cooling plate; and
a heat tube with an evaporator side arranged in the cooling plate and a condenser side arranged outside the cooling plate.

2. The electric motor as claimed in claim 1, wherein the heat pipe comprises a straight line arranged with an inclination of at least 10° to the horizontal.

3. The electric motor as claimed in claim 1, wherein the one or more the circuit boards form a circle or an annular sector.

4. The electric motor as claimed in claim 1, where in the cooling plate is arranged perpendicular to an axis of the electric motor.

5. The electric motor as claimed in claim 1, wherein in which the cooling plate is populated with circuit boards of the one or more circuit boards on both sides.

6. The electric motor as claimed in sclaim 1, further comprising additional heat pipes.

7. The electric motor as claimed in claim 1, operable to control the plurality of field conductors with at least phases.

8. (canceled)

9. The electric motor as claimed in 1, wherein the heat pipe is connected on the condenser side to a plurality of cooling fins.

10. The electric motor as claimed in claim 9, which wherein at least some of the plurality of cooling fins are mechanically connected to multiple heat pipes.

11. The electric motor as claimed in claim 1, wherein:
the cooling plate has includes two cover surfaces and a surrounding jacket surface; and
the circuit boards are arranged on at least one of the cover surfaces; and
the heat pipe passes through the surrounding jacket surface.

12. The electric motor as claimed in is claim 1, wherein:
the cooling plate has two cover surfaces and a surrounding jacket surface;
the circuit boards are arranged on one of the two cover surfaces; and
the heat pipe passes through the other cover surface.

13. The electric motor as claimed in claim 1, which further comprising one or more fans to generate an air flow over the cooling fins.

14. The electric motor as claimed in claim 1, wherein the inverters generate an alternating voltage with an amplitude of 200 V or less.
